(19) United States
(12) Patent Application Publication
(10) Pub. No.: US 2025/0209369 A1
(43) Pub. Date: Jun. 26, 2025

(54) KNOWLEDGE-BASED MACHINE LEARNING SURROGATE MODELS

(71) Applicant: INTERNATIONAL BUSINESS MACHINES CORPORATION, Armonk, NY (US)

(72) Inventors: Joao LUCAS DE SOUSA ALMEIDA, Ibiúna (BR); Alberto Costa Nogueira JUNIOR, Campinas (BR); Leonardo Pondian Tizzei, Campinas (BR); Leonardo SILVEIRA DE ALBUQUERQUE MARTINS, Campinas (BR)

(21) Appl. No.: 18/390,014

(22) Filed: Dec. 20, 2023

(51) Int. Cl. G06N 20/00

(52) U.S. Cl. CPC G06N 20/00

(57) ABSTRACT

Computer implemented methods, systems, and computer program products include program code executing on a processor(s) that identifies, in the target dataset, domain limits and resolution, wherein the domain limits comprise as upper domain limit and a lower domain limit. The processors select one or more support datasets for the target dataset and utilize the support datasets to devise an interpolation model of the target dataset for data points missing between the domain limits in the resolution. The processors generate a representation model of the target dataset between the domain limits and utilize the support dataset to generate a generalization model of the target dataset by utilizing the support datasets to extrapolate values beyond the domain limits.

### BACKGROUND

The present invention relates generally to the field of data machine learning and in particular, a method for improving access to large datasets by deriving and distributing data surrogate models.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

Many scientific discoveries rely on spatiotemporal data representing the input and output information of dynamical systems, usually leveraging sensor measurements and/or simulation data. However, spatiotemporal data sets are commonly very large and, for this reason, are very expensive to store and distribute to end users seeking to process the data and uncover insights with software running on devices connected to the data sources through networks with low bandwidth.

### SUMMARY

Shortcomings of the prior art are overcome, and additional advantages are provided through the provision of a computer-implemented method for generating a surrogate model for use in re-generating a target dataset, stored on a host, on a destination device. The method can include: identifying, by one or more processors, in the target dataset, domain limits and resolution, wherein the domain limits comprise as upper domain limit and a lower domain limit; based on the domain limits and resolution, selecting, by the one or more processors, one or more support datasets for the target dataset; utilizing, by the one or more processors, the support datasets, to devise an interpolation model of the target dataset for limits missing between the domain limits in the resolution; generating, by the one or more processors, a representation model of the target dataset between the domain limits; and utilizing, by the one or more processors, the support dataset, to generate a generalization model of the target dataset, wherein generating the generalization model comprises utilizing the support datasets to extrapolate values beyond the domain limits.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which: FIG. 1 depicts one example of a computing environment to perform, include and/or use one or more aspects of the present disclosure;

FIG. 2 is a workflow that provides an overview of various aspects performed by the program code (executing on one or more processors) in some embodiments of the present disclosure;

FIG. 3 is a workflow that provides an overview of various aspects performed by the program code (executing on one or more processors) in some embodiments of the present disclosure;

FIG. 4 is a workflow that provides an overview of various aspects performed by the program code (executing on one or more processors) in some embodiments of the present disclosure;

FIG. 5 is a workflow that provides an overview of various aspects performed by the program code (executing on one or more processors) in some embodiments of the present disclosure;

FIG. 6 is a workflow that provides an overview of various aspects performed by the program code (executing on one or more processors) in some embodiments of the present disclosure;

FIG. 7 is a workflow that provides an overview of various aspects performed by the program code (executing on one or more processors) in some embodiments of the present disclosure; and

FIG. 8 is a technical environment for executing a workflow that includes various aspects performed by the program code (executing on one or more processors) in some embodiments of the present disclosure.

### DETAILED DESCRIPTION

Many processes utilize spatiotemporal data sets, but because they are commonly very large, they are expensive to store and distribute to end users seeking to process the data. However, various processes that utilize these data sets for insights and exploration do not require full fidelity, and some noise may be acceptable. Spatiotemporal data sets can represent variables and parameters describing discretized dynamical systems commonly governed by widely known laws. Widely known Physics laws, as variants of Navier-Stokes Equations, are the fundamental theory behind, for example, climate models. Thus, embodiments of the present invention include computer-implemented methods, computer program products, and computer systems that includes program code, executing on one or more processors, that as a data curator, determines and describes laws relating spatiotemporal data sets and guides a machine learning algorithm in deriving a data surrogate model. The program code can distribute the surrogate model to users so that the users can utilize the surrogate model to reconstruct data sets in the destination devices. To that end, in the examples herein, program code (e.g., a data curator) obtains a target data set (e.g., a spatiotemporal data set), and assigning other support datasets related to the parameters of implicit dynamics that govern the state variables encompassed in the target dataset.

The examples herein include computer-implemented methods, computer-program products, and computer systems that generate surrogate models for use in re-generating target datasets, stored on a host, on destination devices. Generating these models includes creating surrogate models designed to represent and model (interpolate and extrapolate) target datasets, already stored on a server host, with the aim of using them to recreate data on destination devices, thus circumventing the issue of transferring large amounts of data between machines.

Program code executing on one or more processors selects one or more machine learning algorithms to build an interpolation, representation, and/or generalization model, which comprises a surrogate model of the target dataset. The surrogate model is an application (e.g., software) that the program code can transfer over a network (e.g., to resources communicatively coupled with the one or more processors) to one or more consumer of the target dataset. Each data consumer can utilize the surrogate model to reconstruct the target dataset, locally. In some examples, the program code selects the surrogate model the data consumer can utilize to execute the reconstruction (as the program code can generate more than one surrogate model), based on (x, y, z, t) coordinates requested by the data consumer.

The computer-implemented methods, computer program products, and computer systems described herein are inextricably linked to computing and are directed to a practical purpose. The issue is unique to computing because spatiotemporal data sets are large and are processed on many applications but distributing these data sets to destination devices is prevented and/or adversely affected by the size of the data sets. Thus, the examples herein address an issue inextricably linked to computing, limitations relating to electronic communication and data transmission, and utilize a solution that is also inextricably linked to computing, i.e., training and application of a machine learning algorithm, to address these limitations. The examples described herein provide a practical solution to a technical (computing) limitation. For example, if a user (e.g., application on a destination device), explores features of a spatiotemporal data set but this exploration does not necessarily utilize full fidelity for the set, program code in examples herein can enable this exploration by distributing a surrogate model. Distributing the model for local data reconstruction by the user accelerates and lowers costs of workflows

The examples herein provide significantly more than existing approaches to distributing spatiotemporal data sets over a network to applications and/or destination devices. As will be discussed in greater detail herein, in examples herein, program code comprising a data curator, based on domain limits and resolution, identifies support datasets that help describe the implicit dynamics of a spatiotemporal data, referred to as a target dataset, defined by domain limits and resolution. Based on knowledge of dynamics, the program code data obtains algorithms for interpolation of the data if gaps are identified within a specified domain in order to generate interpolation model results. The program code generates a representation model to represent the original target data set in a reduced form within limits of the domain. The program code selects algorithms to build the representation model based on knowledge about the dynamics. Program code utilizes the algorithms selected to build a generalization model. The generalization model, with the aid of support datasets, can be used to extrapolate beyond the domain limits of the original target dataset. Thus, when a data consumer, over a computing network, requests access to target data (data in the target data set), the program code can deliver a model in place of the data, for local construction. Responsive to a request from the data consumer, the program code automatically selects and sends a model based on domain coordinates requested by the user (requestor) for preliminary exploration. Thus, the examples herein can be understood as a “data-as-software” approach that seamlessly constructs original datasets up to a given accuracy level, providing model-based higher resolution representations and generalization to outside original domain limits by leveraging a data curator's knowledge about the underlying dynamics of the datasets and machine learning techniques. Meanwhile, existing approaches focus primarily on addressing data transmission limitations by selecting and sending part of a data set in place of the whole data set. For at least this reason, the examples herein provide significantly more than existing approaches to distributing spatiotemporal data sets over a network, including to resources that cannot accept/receive transmissions as large as the spatiotemporal data sets.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for generating surrogate models to distribute in place of spatiotemporal data sets 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Many of the examples in the figures include an entity referred to as a Data Curator. A Data Curator can be an entity outside the system described herein, that provides data that aids in determinations made by program code executing on one or more processors. However, the Data Curator can also be part of the program code executing on the one or more processors. Various figures herein depict both possibilities. In both cases, the aspects performed by the Data Curator provide data that guides various other processes.

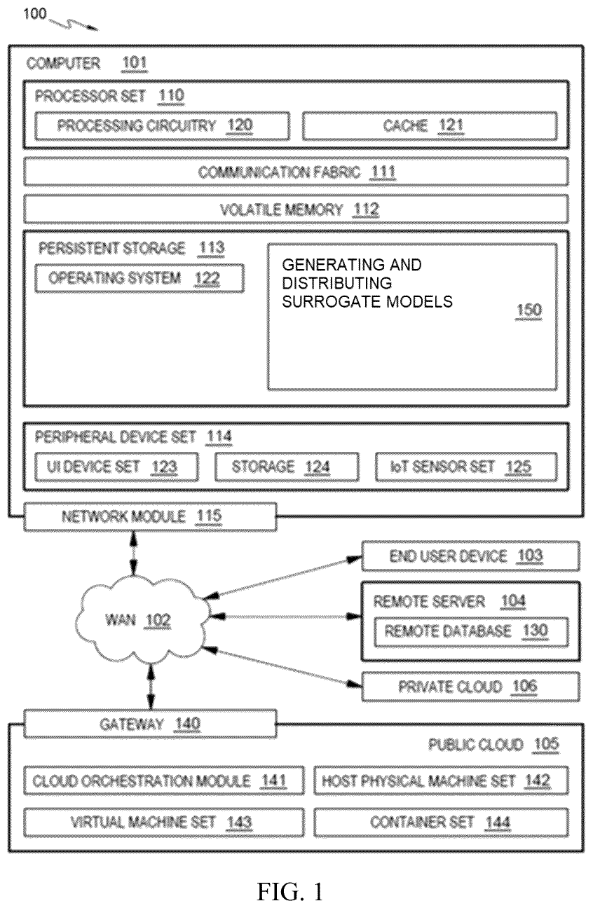

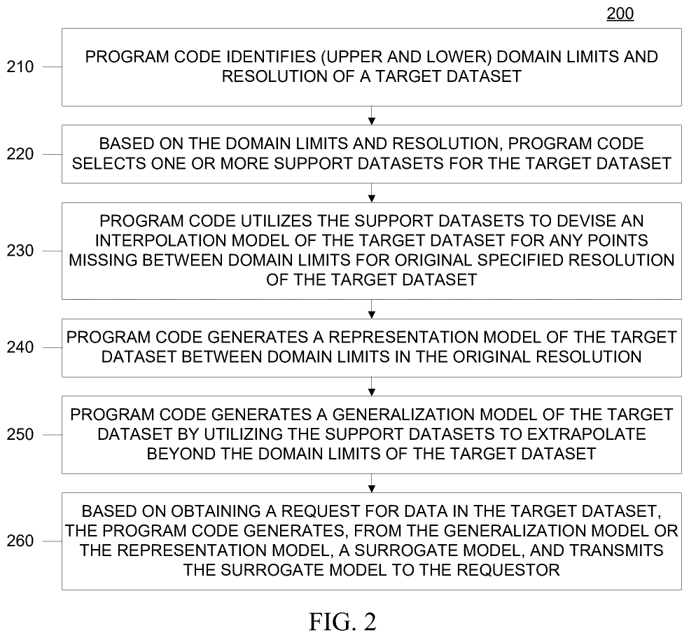

FIG. 2 is a general workflow 200 that includes various aspects of some examples herein. The elements of this workflow 200 are explained in greater detail with the additional figures. However, as illustrated in the workflow 200 of FIG. 2, program code in some examples herein identifies domain limits (x̅, y̅, z̅, t̅) and (x, y, z, t), and resolution (Δx, Δy, Δz, Δt) of a target dataset (e.g., a spatiotemporal data set) (210). This target dataset, in some examples, was obtained by the program code from an original source and may have been previously normalized or otherwise processed before being saved as the target dataset. Based on the domain limits and resolutions, the program code selects one or more support datasets for the target dataset (220). The program code utilizes the support datasets to devise an interpolation model of the target dataset for any data points (x, y, z, t) missing between domain limits for original specified resolution of the target dataset (230). The program code generates a representation model of the target dataset between domain limits in the original resolution (240). The program code generates a generalization model of the target dataset by utilizing the support datasets to extrapolate beyond the domain limits of the target dataset (250). Based on obtaining a request for data in the target dataset, the program code generates, from the generalization model or the representation model, a surrogate model, and transmits the surrogate model to the requestor (260). The requestor can utilize the surrogate model to generate the requested data of the target data set at the location of the requestor (e.g., on a destination device).

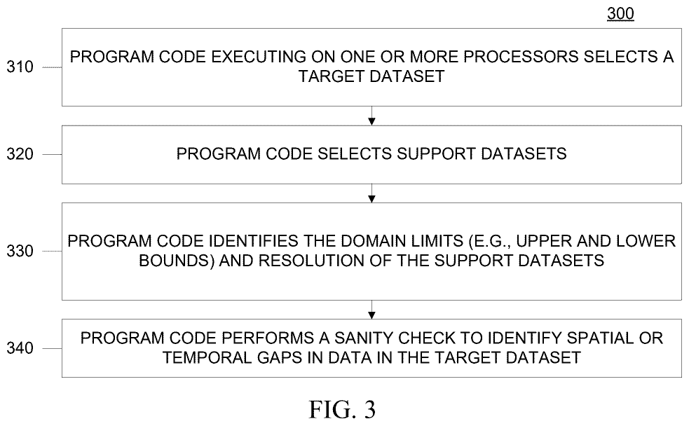

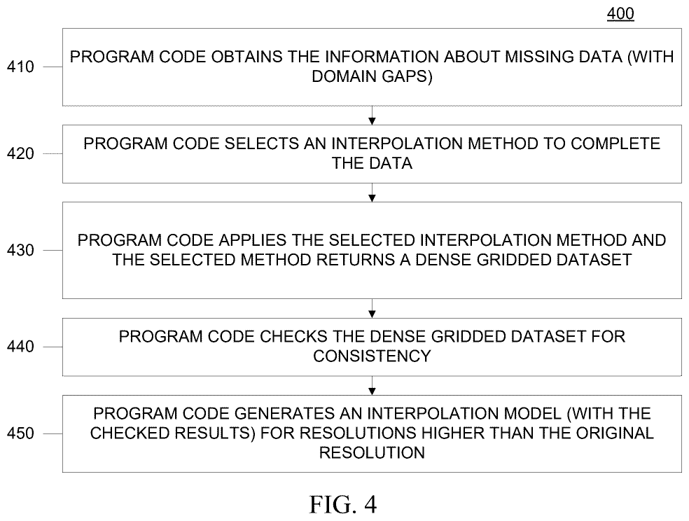

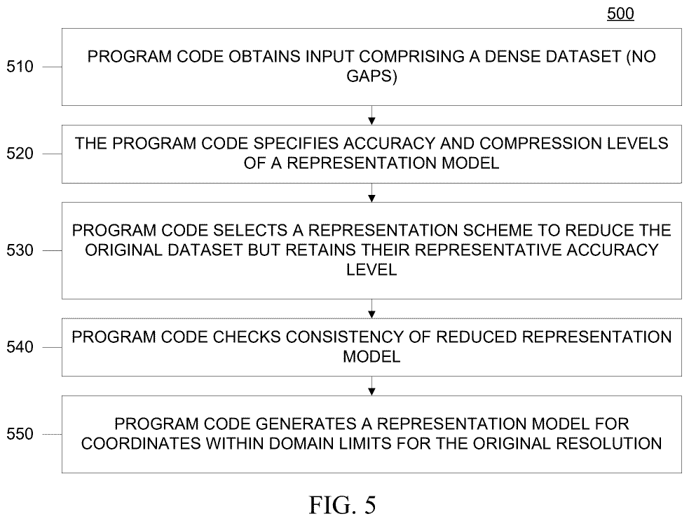

In some examples, various aspects of the workflow 200 can be performed by different modules. This modular representation is a non-limiting example of how various aspects of the workflow 200 can be implemented across a computing system. This particular configuration was selected for illustrative purposes only to promote a clear understanding of each aspect. Hence, FIG. 3 illustrates the program code (e.g., a data curator) selecting one or more support datasets for the target dataset (e.g., FIG. 2, 220). FIG. 4 illustrates program code interpolating limits and generating an interpolation model (e.g., FIG. 2, 230). FIG. 5 illustrates the program code generating a representation model (e.g., FIG. 2, 240).

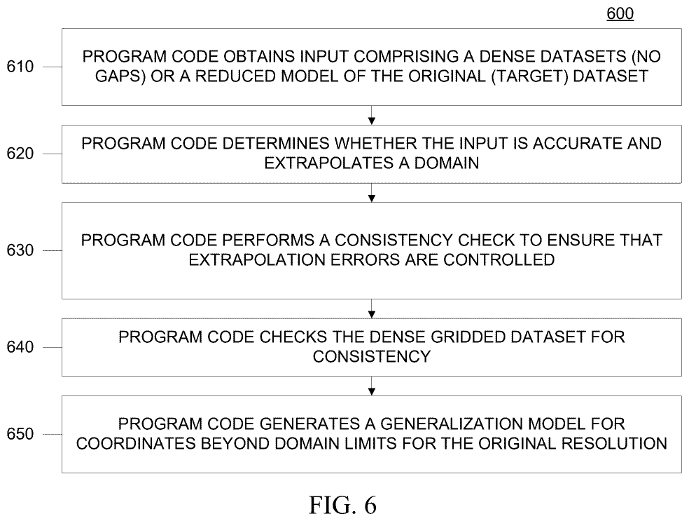

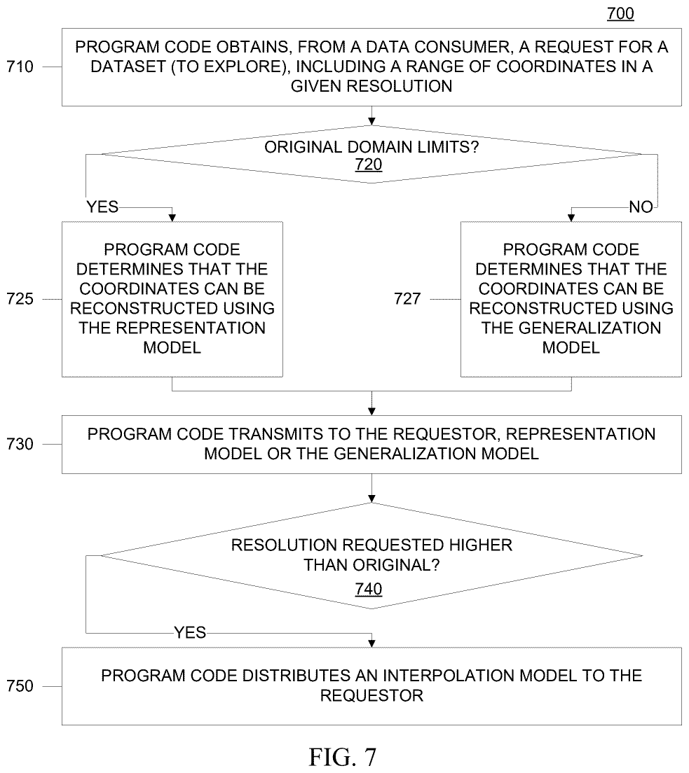

FIG. 6 illustrates the program code generating a generalization model (e.g., FIG. 2, 250). Finally, FIG. 7 illustrates the program code delivering data-as-software (e.g., FIG. 2, 270).

Referring to FIG. 3, the program code identifies support datasets based on a target dataset for which the program code has previously identified the domain limits and resolution. To that end, program code executing on one or more processors, (which can be understood as a data curator) selects a target dataset (310). The program code will use the target dataset to train a model. In general, data curators are data specialists (including automated processes) who collect, organize, clean, and transform data to make it accessible for organizations and individuals. Data curators may gather new data or perform a more thorough analysis of existing research. The program code selects support datasets (320). In some examples, based on the domain limits and resolution of the target dataset, the program code determines a set of support datasets to aid model construction, including but not limited to, forcing variables. As illustrated in FIG. 2, the program code obtains the domain limits and resolution of the target dataset (210), however, the program code identifies the domain limits (e.g., upper and lower bounds) and resolution of the support datasets (330). The program code can evaluate global metrics to determine the limits and resolution for one or more of the target dataset and the support datasets. The program code can perform a sanity check to identify spatial or temporal gaps in data in the target dataset (340). To that end, the program code determines whether there are gaps (missing data) inside a domain of the target dataset and the program code stores information about missing data.

As illustrated in FIG. 3, the program code stores information about missing data (340). Transitioning to the workflow of FIG. 4, the program code obtains the information about missing data (with domain gaps) (410). The program code selects an interpolation method (including based on pre-determined factors or business rules and/or dynamically based on the information itself) to complete the data (420). The interpolation method selected by the program code can include, but is not limited to linear interpolation, cubic spline interpolation, and/or generic machine learning super resolution. The program code applies the selected interpolation method, and the selected method returns a dense gridded dataset (430). The program code checks the dense gridded dataset for consistency (440). The checked results set is an interpolation model with results for resolutions higher than the original resolution (450).

Once the program code has filled in the data gaps, the program code can generate a generalization model. FIG. 5 is a workflow 500 that describes aspects of this process in some examples herein. Based on the workflows 300 400 of FIGS. 3-4, the workflow of FIG. 5 commences when the program code obtains input comprising a dense datasets (no gaps) (510). The program code specifies accuracy and compression levels of a representation model (520). In some examples, the program code can obtain these levels from another resources, including but not limited to, the data curator. As aforementioned, the data curator can be an outside entity and/or process and it can also be an aspect performed within a computing system executing the aspects described herein. In some examples, the data curator can be understood as a neural implicit flow. The program code selects a representation scheme to reduce the original dataset but retains their representative accuracy level (530). The program code can select schemes including, but not limited to principal component analysis (PCA), neural implicit flow (NIF), a deep operator network (DeepONet), and/or a fully connected network, including but not limited to a multi-layer perceptron ((MLP) neural network. Certain of these processes as well as processes utilized to derive a generalization model, which are discussed herein, including in FIG. 6, can utilize one or more neural networks.

Neural networks refer to a biologically inspired programming paradigm which enables a computer to learn from observational data. This learning is referred to as deep learning, which is a set of techniques for learning in neural networks. Neural networks, including modular neural networks, are capable of pattern recognition with speed, accuracy, and efficiency, in situations where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in physics-informed surrogate modeling, in addition to image recognition, speech recognition, and natural language processing. Neural networks can model complex relationships between inputs and outputs to identify patterns in data, including in images, for classification.

Returning to FIG. 5, the program code performs a consistency check to ensure that errors are controlled (530). The program code performs the consistency check on the reduced representation model of the original data sets to maintain reconstruction errors bounded. Based on the check, the program code has generated a representation model for coordinates within domain limits for the original resolution (540).

Depending on details provided by a requestor, the program code can distribute a surrogate model by utilizing either the representation model or the generalization model. Based on the workflows 300 400 of FIGS. 3-4, the workflow of FIG. 6 commences when the program code obtains input comprising dense datasets (no gaps) or a reduced model of the original (target) dataset (610). Hence, the program code obtains interpolation model results for resolutions higher than the original and representation model results for coordinates within domain limits for the original resolution. The program code determines whether the input is accurate and extrapolates a domain (620). The program code (e.g., the data curator) can specify the accuracy level and the extrapolation domain of the predictive model that extrapolates to unobserved spatial and/or temporal domains. The program code selects a generalization scheme (630). The generalization scheme can be understood as an inference scheme that extrapolates (in space and/or time) the original dense target dataset. The inference scheme can include but is not limited to multi-layer perceptron (MLP), neural implicit flow (NIF), a deep operator network (DeepONet), and/or operator inference (OpInf). Certain of these processes can utilize one or more neural networks. The program code performs a consistency check to ensure that extrapolation errors are controlled (640). Based on the check, the program code has generated a generalization model for coordinates beyond domain limits for the original resolution (650).

Once the program code has generated the representation model and the generalization model, the program code can utilize this models to distribute software (surrogate models) that enable various devices/applications/users, that request the target dataset (over the network), to receive, instead of the dataset, which is often too large to transmit or to otherwise transfer to destination devices and is even more often inefficient to transmit to the destination devices, this software, which is can be utilized to generate the requested dataset, locally. FIG. 7 illustrates the workflow 700 of the program code, executing on one or more processors, providing a surrogate model to a data consumer. As illustrated in FIG. 7, the program code obtains, from a data consumer, a request for a dataset (to explore), including a range of coordinates in a given resolution (710). From the perspective of the requestor, the requestor can connect to a node of a computing system in contact with one or more processors, for example, via an application programming interface (API), and select (e.g., via an interface including a graphical user interface), a dataset to explore. As aforementioned, various user applications utilize spatiotemporal datasets for exploration as well as for various purposes. In some examples, the requestor can also request a range of coordinates and specify a resolution. In some examples, the aspects described herein can be embedded in high level large-scale data manipulation APIs, including but not limited to, Xarray, dask, vaex, etc.

Returning to FIG. 7, for every coordinate in the range, the program code verifies if it is in the original domain limits to determine which model to distribute to the requestor (720). Depending on the implementation of the aspects described herein, the selection and management of the models by the program code and their requirements can be transparent to the data consumer. For example, the program code can generate a visualization of its selection processes and display them to a user, e.g., via a GUI. Based on determining that the coordinates are within the original domain limits, the program code determines that the coordinates can be reconstructed using the representation model (725). Based on determining that the coordinates are not within the original domain limits, the program code determines that the coordinates can be reconstructed using the generalization model (727). The program code transmits to the requestor, representation model or the generalization model (730). In some examples, the program code determines if the resolution requested by the requestor is higher than the original resolution of the requested dataset (740). Based on determining that the resolution is higher, the program code distributes an interpolation model to the requestor (750). Upon receipt of the models, the destination device can apply the model it received to reconstruct the coordinates. If the resolution requested by the requestor was higher than the original resolution of the requested dataset, the requestor can apply the interpolation model to increase the resolution. In this manner, the dataset is recreated with the requested coordinates and resolution local to the requestor without transmitting the dataset itself to the requestor. In this manner, the spatiotemporal data is not available to the requestor/consumer.

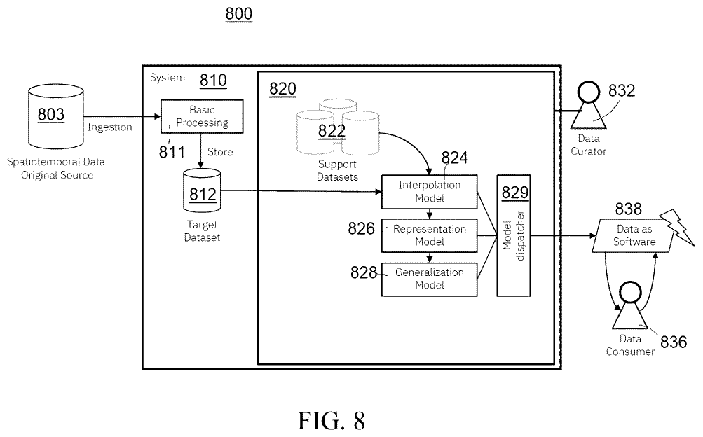

FIG. 8 provides a system overview of a technical environment 800 into which aspects of the examples herein have been implemented. In this example, although the data curator and the data consumer are depicted as individuals, these depictions can also represent processes (e.g., software or hardware). This personalization is provided as non-limiting example. Also, for ease of understanding and illustration, various functionalities are separated into software and/or hardware modules. The configuration and the separation of modules provided is a non-limiting example as one or more aspects can be combined or separated out into various examples. FIG. 8 illustrates a technical environment 800 that includes a computer system 810, which is executing aspects of an example of an approach 820 described herein for providing data-as-software, and aspects of the approach 820 itself. The data-as-software approach enables program code executing on one or more processors to deliver instruction (in the form of a model) to reconstruct a dataset (with errors) in the EUD.

As illustrated in FIG. 8, program code executing on one or more processors of a computing system 810 in a technical environment 800 ingests spatiotemporal data from an original source 803. Program code processes the data from the original source 803 (e.g., basic processing 811), and stores it as a target dataset 812 in a resource accessible to the one or more processors of the system 810. A data curator (which can be a process, an application, a person, etc.) 832, identifies support dataset 822 within the computer system 810 and/or accessible to one or more processors of the computer system, 810. The support dataset 822 helps describe implicit dynamics of the target dataset 812. Then, as described in FIGS. 3-6, the program code generates an interpolation model 824, a representation model 826, and a generalization model 828 (referencing the support dataset 822 and/or the target dataset 812). Based on coordinates (x, y, z, t) requested by the Data Consumer 836, the program code selects the best model (as illustrated in FIG. 7) to distribute to enable the Data Consumer 836 to construct the target dataset 812, locally. The program code (e.g., model dispatcher 829) dispatches the model (as illustrated in FIG. 7). Hence, the program code (e.g., model dispatcher 829) transmits the model, which is, effectively, data as software 838.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from the spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of generating a surrogate model for use in re-generating a target dataset, stored on a host, on a destination device, the method comprising:
identifying, by one or more processors, in the target dataset, domain limits and resolution, wherein the domain limits comprise as upper domain limit and a lower domain limit;
based on the domain limits and resolution, selecting, by the one or more processors, one or more support datasets for the target dataset;
utilizing, by the one or more processors, the support datasets, to devise an interpolation model of the target dataset for limits missing between the domain limits in the resolution;
generating, by the one or more processors, a representation model of the target dataset between the domain limits; and
utilizing, by the one or more processors, the support dataset, to generate a generalization model of the target dataset, wherein generating the generalization model comprises utilizing the support datasets to extrapolate values beyond the domain limits.

2. The computer-implemented method of claim 1, further comprising:
obtaining, by the one or more processors, a request for data in the target dataset from the destination device;
generating, by the one or more processors, from the generalization model or from the representation model, a surrogate model; and
transmitting, by the one or more processors, the surrogate model to the requestor, wherein upon receipt, the requestor can utilize the surrogate model to generate a local copy of the portion of the target dataset on the destination device.

3. The computer-implemented method of claim 1, wherein selecting the one or more support datasets for the target dataset comprises:
identifying, by the one or more processors, domain limits of the support datasets, the domain limits of the support datasets comprising upper bounds and lower bounds; and
performing, by the one or more processors, a sanity check on the target dataset to identify spatial or temporal gaps.

4. The computer-implemented method of claim 3, wherein devising the interpolation model further comprises:
utilizing, by the one or more processor, the identified spatial or temporal gaps, to select an interpolation method to complete data comprising the target dataset;
applying, by the one or more processors, the selected interpolation method, wherein the applying comprises generating a dense gridded dataset; and
utilizing, by the one or more processors, the dense gridded dataset to generate the interpolation model, wherein the interpolation model comprises data for higher resolutions than the resolution of the target dataset.

5. The computer-implemented method of claim 4, wherein generating the representation model comprises:
obtaining, by the one or more processors, the dense gridded dataset;
obtaining, by the one or more processors, accuracy and compression levels for the representation model;
selecting, by the one or more processors, a representation scheme to reduce the target dataset and retain the specified accuracy level based on the dense gridded dataset;
applying, by the one or more processors, the representation scheme to reduce the target dataset;
checking, by the one or more processors, the reduced target dataset for consistency; and
generating, by the one or more processors, the representation model based on the reduced target dataset, wherein the representation model represents coordinates within domain limits for the resolution of the target dataset.

6. The computer-implemented method of claim 5, wherein generating the generalization model of the target dataset comprises:
obtaining, by the one or more processors, the dense gridded dataset and the reduced target dataset;
determining, by the one or more processors, whether the reduced target dataset and the dense gridded dataset are accurate to extrapolate a domain based on the determination;
based on determining that the obtained dataset is accurate, performing, by the one or more processors, a consistency check to control errors in the extrapolating;
checking, by the one or more processors, the dense gridded dataset for consistency; and
based on the checking, generating, by the one or more processors, the generalization model for coordinates beyond the domain limits of the target dataset with the resolution of the target dataset.

7. The computer-implemented method of claim 1, wherein the target dataset is a spatiotemporal dataset.

8. The computer-implemented method of claim 1, further comprising:
obtaining, by the one or more processors, from a destination device of a data consumer, a request for the target dataset, wherein the request comprises a range of coordinates in a given resolution; and
determining, by the one or more processors, if the range of coordinates are within the domain limits of the target dataset.

9. The computer-implemented method of claim 8, further comprising:
based on determining that the range of coordinates are within the domain limits of the target dataset, transmitting, by the one or more processors, to the destination device, the representation model.

10. The computer-implemented method of claim 8, further comprising:
based on determining that the range of coordinates are not within the domain limits of the target dataset, transmitting, by the one or more processors, to the destination device, the generalization model.

11. The computer-implemented method of claim 9, further comprising:
determining, by the one or more processors, if the given resolution is higher than the resolution of the target dataset; and
based on determining that the given resolution is higher, transmitting, to the destination device, the interpolation model.

12. The computer-implemented method of claim 10, further comprising:
determining, by the one or more processors, if the given resolution is higher than the resolution of the target dataset; and
based on determining that the given resolution is higher, transmitting, to the destination device, the interpolation model.

13. A computer system for generating a surrogate model for use in re-generating a target dataset, stored on a host, on a destination device, the computer system comprising:
a memory; and
one or more processors in communication with the memory, wherein the computer system is configured to perform a method, said method comprising:
identifying, by the one or more processors, in the target dataset, domain limits and resolution, wherein the domain limits comprise as upper domain limit and a lower domain limit;
based on the domain limits and resolution, selecting, by the one or more processors, one or more support datasets for the target dataset;
utilizing, by the one or more processors, the support datasets, to devise an interpolation model of the target dataset for limits missing between the domain limits in the resolution;
generating, by the one or more processors, a representation model of the target dataset between the domain limits; and
utilizing, by the one or more processors, the support dataset, to generate a generalization model of the target dataset, wherein generating the generalization model comprises utilizing the support datasets to extrapolate values beyond the domain limits.

14. The computer system of claim 13, further comprising:
obtaining, by the one or more processors, a request for data in the target dataset from the destination device;
generating, by the one or more processors, from the generalization model or from the representation model, a surrogate model; and
transmitting, by the one or more processors, the surrogate model to the requestor, wherein upon receipt, the requestor can utilize the surrogate model to generate a local copy of the portion of the target dataset on the destination device.

15. The computer system of claim 13, wherein selecting the one or more support datasets for the target dataset comprises:
identifying, by the one or more processors, domain limits of the support datasets, comprising upper bounds and lower bounds; and
performing, by the one or more processors, a sanity check on the target dataset to identify spatial or temporal gaps.

16. The computer system of claim 15, wherein devising the interpolation model further comprises:
utilizing, by the one or more processor, the identified spatial or temporal gaps, to select an interpolation method to complete data comprising the target dataset;
applying, by the one or more processors, the selected interpolation method, wherein the applying comprises generating a dense gridded dataset; and
utilizing, by the one or more processors, the dense gridded dataset to generate the interpolation model, wherein the interpolation model comprises data for higher resolutions than the resolution of the target dataset.

17. The computer system of claim 16, wherein generating the representation model comprises:
obtaining, by the one or more processors, the dense gridded dataset;
obtaining, by the one or more processors, accuracy and compression levels for the representation model;
selecting, by the one or more processors, a representation scheme to reduce the target dataset and retain the specified accuracy level based on the dense gridded dataset;
applying, by the one or more processors, the representation scheme to reduce the target dataset;
checking, by the one or more processors, the reduced the target dataset for consistency; and
generating, by the one or more processors, the representation model based on the reduced target dataset, wherein the representation model represents coordinates within domain limits for the resolution of the target dataset.

18. The computer system of claim 17, wherein generating the generalization model of the target dataset comprises:
obtaining, by the one or more processors, the dense gridded dataset and the reduced target dataset;
determining, by the one or more processors, whether the reduced target dataset and the dense gridded dataset are accurate to extrapolate a domain based on the determination;
based on determining that the obtained dataset is accurate, performing, by the one or more processors, a consistency check to control errors in the extrapolating;
checking, by the one or more processors, the dense gridded dataset for consistency; and
based on the checking, generating, by the one or more, the generalization model for coordinates beyond the domain limits of the target dataset with the resolution of the target dataset.

19. The computer system of claim 13, wherein the target dataset is a spatiotemporal dataset.

20. A computer program product for generating a surrogate model for use in re-generating a target dataset, stored on a host, on a destination device, the computer program product comprising:
one or more computer readable storage media and program instructions collectively stored on the one or more computer readable storage media readable by at least one processing circuit to:
identify, in the target dataset, domain limits and resolution, wherein the domain limits comprise as upper domain limit and a lower domain limit;
based on the domain limits and resolution, select one or more support datasets for the target dataset;
utilize the support datasets to devise an interpolation model of the target dataset for limits missing between the domain limits in the resolution;
generate a representation model of the target dataset between the domain limits; and
utilize the support dataset to generate a generalization model of the target dataset, wherein generating the generalization model comprises utilizing the support datasets to extrapolate values beyond the domain limits.
